(19) United States
(12) Patent Application Publication
(10) Pub. No.: US 2008/0218511 A1
(43) Pub. Date: Sep. 11, 2008

(54) DESIGN METHOD AND RECORDING MEDIA

(75) Inventor: Youji UCHIKURA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/041,968

(22) Filed: Mar. 4, 2008

(30) Foreign Application Priority Data
Mar. 7, 2007 (JP) 2007-57823

(51) Int. Cl. G06T 15/00

(52) U.S. Cl. 345/419

(57) ABSTRACT

According to an aspect of an embodiment, a method comprises an extracting detailed shape information which is unnecessary for a simulation from data of a three-dimension CAD model, simplifying the detailed shape information, and creating a simplified model in which the detailed shape information included in the data of three-dimension CAD model is replaced with simplified shape information.

### CROSS-REFERENCE TO RELATED APPLICATIONS

This application is related to and claims the benefit of priority from Japanese Patent Application No. 2007-57823, filed on Mar. 7, 2007, the entire contents of which are incorporated herein by reference.

### BACKGROUND

1. Field

This art relates to a design technique for designing a design object such as a component or a product by a computer.

2. Description of the Related Art

In designing a component or product with the CAD system, analyses, evaluation and optimization are performed at a design phase. The analyses include various analyses of such as structure, heat, electric wave and oscillation. A necessity of design change can be judged by evaluating the analyses results of a three-dimension CAD model designed. The three-dimension CAD model can be optimized by changing its design based on the analyses results. The analyses, evaluation and optimization are sometimes performed using a design support tool for simulation.

The three-dimension CAD model can be used as a simulation model in simulating said analyses, evaluation and optimization. However, the three-dimension CAD model includes information on its shape in detail in order to reflect necessary information into fabrication, assembling, drawing linkage and fabrication linkage of the component or the product. Hence the shape information includes shapes of cutouts and protrusions. The drawing linkage is an operation to convert coordinate data in three-dimension relating to the three-dimension CAD model to coordinate data in two-dimension. The fabrication linkage is e.g. processing a metallic plate to a metallic component having a certain shape by a process machinery by inputting shape data of the metallic component into the processing machinery.

The data of the three-dimension CAD model includes information on complicated and detailed shapes and therefore the simulation of the analyses, evaluation and optimization includes the unnecessary shape information. If the data of the three-dimension CAD model is simulated without removing the unnecessary shape information, the unnecessary shape information is also simulated. Which make the simulation complicated so the simulation time, especially the analyses time, takes much longer. Thus, in a conventional manner, an operator (designer) simplifies the detailed shape information included in the data of the three-dimension CAD model, which is unnecessary for the simulation, manually based on a type of the simulation or a dimension of the three-dimension CAD model.

Where interference exists between components of a device assembled from a plurality of components, which interferes the simulation of the three-dimension CAD model of the device. Concretely speaking, the interference interferes some sorts of the simulation so that the three-dimension CAD model of the component's shape should be modified to a shape having no interference. So the operator has modified the component's shape manually in order to remove the interference according to the sort of the simulation.

In conventional methods, the operator creates the simplified model in which the detailed shape, which is unnecessary for the simulation, from the three-dimension CAD model manually, so an operation to curtail the simulation time takes time and an efficiency of the operation depends upon the operator's proficiency.

In addition, the operator modifies the three-dimension CAD model to the modified model having no interference in order to eliminate a hindrance of the simulation. This modification takes time and the efficiency of the modification depends upon the operator's proficiency.

A method is desired to address the problems of time required to perform simulations, to reduce the operations that have been to be performed manually, and to decrease the dependency on the operator's proficiency level.

### SUMMARY

This technique aims to provide a design method, a program, a CAD system and a computer-readable recording media for creating a simplified model in which the unnecessary shape of the three-dimension CAD model for the simulation is simplified, and/or modifying the three-dimension CAD model to the modified model having no interference automatically, which are independent of the operator's proficiency.

According to an aspect of an embodiment, a method comprises extracting detailed shape information which is unnecessary for a simulation from data of a three-dimension CAD model, simplifying the detailed shape information and a creating operation creating a simplified model in which the detailed shape information included in the data of three-dimension CAD model is replaced with simplified shape information.

Additional aspects and/or advantages will be set forth in part in the description which follows and, in part, will be apparent from the description, or may be learned by practice of the present invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating a computer system according to an embodiment;

FIG. 2 is a block diagram illustrating a structure of a main unit of the computer system-;

FIGS. 3A and 3B are views of an example three-dimension CAD model-;

FIGS. 4A and 4B are views of an example of a three-dimension CAD model-,

FIGS. 5A, 5B, and 5C illustrate a filling processing-,

FIGS. 6A, 6B, and 6C illustrate a removal processing;

FIGS. 7A, 7B, and 7C illustrate examples of a three-dimension CAD model;

FIGS. 8A and 8B illustrate examples of a three-dimension CAD model;

FIG. 9 is a flow chart illustrating example processes of an embodiment;

FIG. 10 is a prospective view of a model illustrating an example of modification methods M1 and M2;

FIG. 11 is a prospective view of a model illustrating an example of modification method M1;

FIG. 12 is a prospective view of a model illustrating an example of modification method M2;

FIG. 13 is a prospective view of a model illustrating an example of modification method M3;

FIG. 14 is a prospective view of a model illustrating an example of modification method M3;

FIG. 15 is shows a prospective view of a model illustrating an example of modification method M3;

FIG. 16 is a flow chart illustrating example processes of an embodiment, and.

FIG. 17 illustrates are block diagram of another embodiment.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Shape information on the complicated and/or detailed shape that is unnecessary for the simulation is extracted from the data of the three-dimension CAD model, and the detailed shape information extracted is simplified and then the simplified model is created by replacing the detailed shape information of the data of the three-dimension CAD model with the simplified shape information. Then the simplified model thereby created is simulated. The simulation can include analyses, evaluation and optimization, e.g., only the analyses can be performed, or the analyses and evaluation, or the analyses, evaluation and optimization can be performed. In this simulation, the unnecessary shape information for the simulation included in the three-dimension CAD model can be automatically simplified according to an attribute of a simulation type or a dimension of the three-dimension CAD model. Therefore the simulation time, especially the time for simplifying the shape information to reduce the analyses time is reduced, and the efficiency of the simplification does not depend upon the operator's proficiency.

Extracting the interference between the components from the data of the three-dimension CAD model and modifying the interfering component's shape based on the extracted portion and crating the modified model having no interference can be added to the processes. Then the data of the modified model thereby created can be simulated. The modification of the three-dimension CAD model to the modified model having no interference can be performed automatically based on the simulation type or the dimension of the three-dimension CAD model. Therefore the shape modification time of the component to perform the simulation does not take time and the efficiency of the modification can be independent of the operator's proficiency.

An example design method, program, CAD system and computer-readable memory medium of embodiments will be described hereinafter with reference to the drawings.

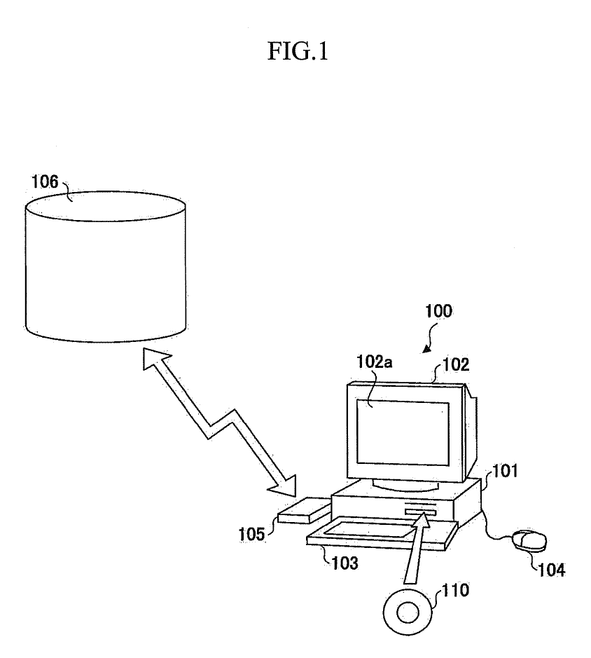

A program, CAD system and computer-readable memory medium can use the example design method. FIG. 1 shows an example computer system that can be used.

A computer system 100 shown in FIG. 1 includes a main unit 101 including a CPU and a disk drive, a display 102 displaying image of element created by an element creation simulation on a display screen 102a with a command sent from the main unit 101, a keyboard 103 for inputting various information into the computer system 100, a mouse 104 for specifying an arbitrary position on the display screen 102a of the display 102 and a modem 105 for accessing an external database to download program stored in other computer system.

A CAD program for the computer system 100 can be stored in the portable memory media such as the disk 110 or downloaded from the memory media 106 of the other computer system by using a communication device such as the modem 105, is input into the computer system 100 and then complied in it. The program actuates the computer system 100 (i.e. a CPU 201 after-mentioned) as the CAD system having the CAD feature. The program can be stored in the computer-readable recording media such as a disk 110. The computer-readable recording media herein-mentioned is not limited to the portable recording media such as the disk 110, an IC card memory, a magnetic disk such as a floppy disk (registered brand), a magneto optical disk and a CD-ROM but includes various memory medium that can be accessible via the communication device or communications such as the model 105 or a LAN.

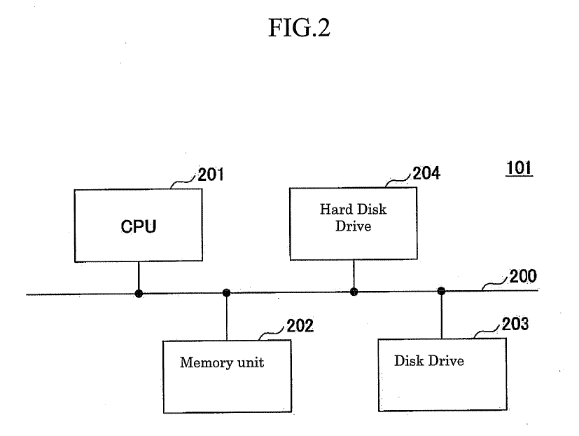

FIG. 2 shows a block diagram of example parts within the main unit 101 of the computer system 100. The main unit 101 shown in FIG. 2 is comprised of the CPU 201 connected via a bus 200, a memory unit 202 having a RAM and a ROM, a disk drive 203 for the disk 110 and a hard disk drive (HDD) 204. In this embodiment, the display 102, the keyboard 103 and the mouse 104 connect with the CPU 201 via the bus 200, however, they can also connect with the CPU 201 directly. Alternatively, the display 102 can connect with the CPU 201 via a commonly-known graphic interface (not illustrated) processing input/output image data.

The keyboard 103 and the mouse 104 of the computer system 100 are a way to provide input for the CAD system. The display 102 can display the three-dimension CAD model on the display screen 102a. The CPU 201 can extract the information on the complicated and/or detailed shape that is unnecessary for the simulation from the data of the three-dimension CAD model, simplify the detailed shape information extracted, creating the simplified model from the three-dimension CAD model by replacing said detailed shape information with the simplified shape information and simulating the data of the simplified model thereby created. The simulation includes the analyses, evaluation and optimization, and individually can be conventional simulations.

The configuration of the computer system 100 is not limited to the configuration shown in FIG. 1 and 2, and can be various types of conventional configurations.

In this embodiment, in order to reduce the simulation time, especially the analysis time, the complicated and/or detailed shape information is extracted from the data of the three-dimension CAD model in performing various simulations of the three-dimension CAD model of the component and the product designed with the CAD system using a conventional method, and the detailed shape information extracted is simplified, then the simplified model can be created from the three-dimension CAD model's data by replacing said detailed shape information with the simplified shape information. Then the simplified model's data thereby created can be simulated. Thus the simulation time, especially the analyses time, can be curtailed by simplifying the detailed shape information that does not affect major impact on a result of the simulation.

A portionn where the ratio of a distance between edges, a length of an edge and a distance between vertices of a targeted three-dimension CAD model to its maximum outer shape is less than a prescribed ratio can be extracted. The prescribed value can be configured arbitrarily.

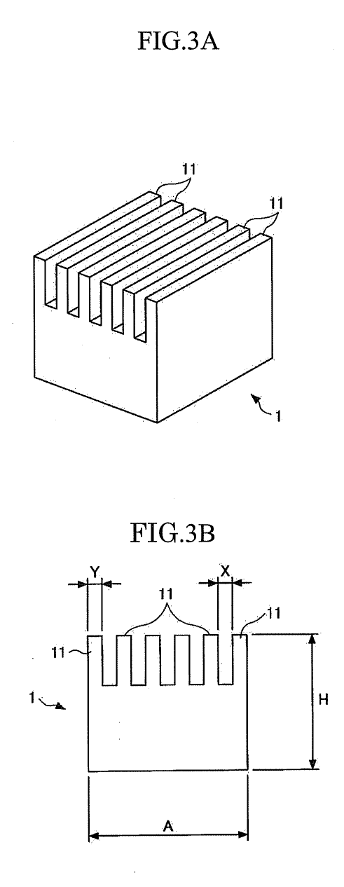

FIGS. 3A and 3B show views of an example of three-dimension CAD model. FIG. 3A shows a prospective view of a three-dimension CAD model 1 and FIG. 3B shows a front view of the three-dimension CAD model 1. For the three-dimension CAD model 1 having a shape as shown in FIGS. 3A and 3B, where a dimension of an edge 11, Y, to an outer shape A in a lateral direction can be given by Y≦A/10, the edge 11 is judged as the complicated and/or detailed shape to be extracted. Where a distance between the edges 11, X, can be given by X≦A/10, the portions of the edges 11 are judged as the complicated and/or detailed shape to be extracted. In this case, the judgment value is A/10, however, non-A/10 can be configured arbitrarily.

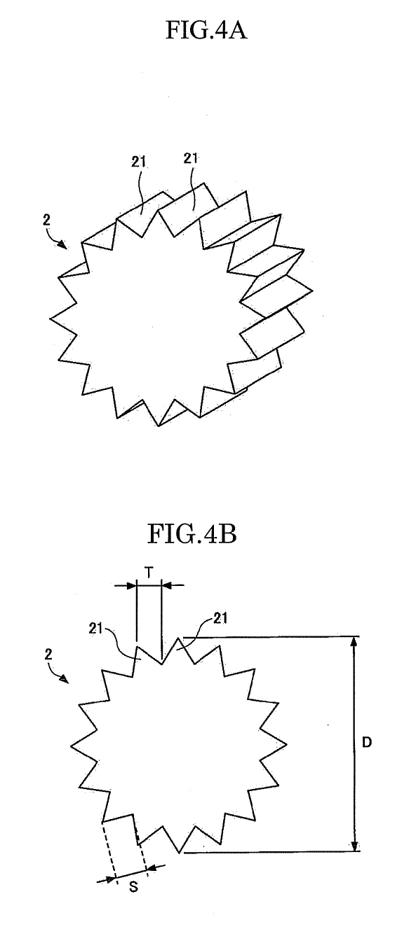

FIGS. 4A and 4B show views of an example of three-dimension CAD model. FIG. 4A shows a prospective view of a three-dimension CAD model 2 and FIG. 4B shows a front view of the three-dimension CAD model 2. For the three-dimension CAD model as per FIGS. 4A and 4B, where a pitch of a wedge 21, T, and a depth of the wedge 21, S, to a maximum outer shape can be given by T≦D/10 and S≦D/10, the wedged portions 21 are judged as the complicated and detailed shape to be extracted. In this case, a judgment value is D/10, however, non-D/10 can be configured arbitrarily.

Dimension parameters of the three-dimension CAD model 1 and 2, A, X, Y, D, S, T can be derived based on coordinate information of the three-dimension CAD model 1 and 2.

A judgment whether the detailed shape information affects the simulation result is made based on the attribute of the simulation type or a predetermined component or product.

The simplified model can be created by the filling processing that fills the interspaces formed by the detailed shapes or the removal processing that removes the detailed shape, based on the detailed shape extracted.

A judgment whether to perform the filling processing or the removal processing can be made based on a ratio of the actual cubic volume of the three-dimension CAD model to a cubic volume of the maximum outer shape or a cubic volume of the simplified model of the three-dimension CAD model. Where the ratio of the cubic volumes is equal or greater than a prescribed value, the filling processing can be performed. Where the ratio is less than the prescribed value, the removal processing can be performed.

Where the filling processing is chosen, the actual cubic volume of the three-dimension CAD model and the cubic volume of the maximum outer shape are derived from the detailed shape extracted from the three-dimension CAD model. Then a simplified model can be created by filling the interspaces formed by the detailed shape based on the cubic volumes derived.

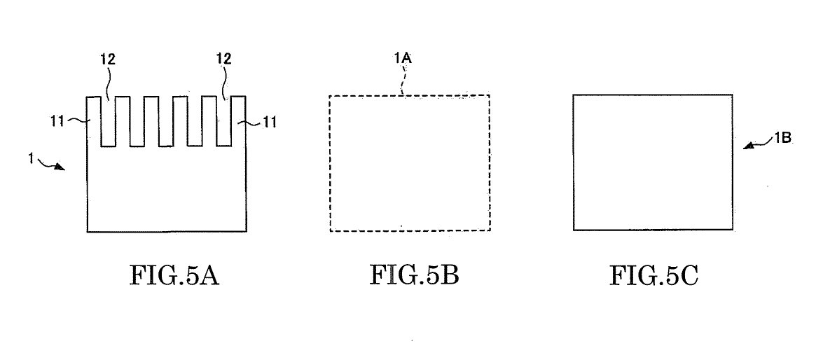

FIGS. 5A-5C illustrate the filling processing. FIG. 5A is a front view of the three-dimension CAD model 1. FIG. 5B shows a front view of a maximum outer shape of the three-dimension CAD model 1 by dashed line. FIG. 5C shows a front view of the simplified model 1B having a simplified shape created by the filling processing. An actual cubic volume of the three-dimension CAD model 1 (i.e. a cubic volume before simplification) can be defined as V1 and a cubic volume of the three-dimension CAD model after the simplification (i.e. a cubic volume of the maximum outer shape 1A) can be defined as V2. Where an equation VIN2≧0.7 is satisfiable, the detailed shape of the three-dimension CAD model is simplified by filling interspaces 12 between the edges 11, thereby a simplified model 1B can be created. A judgment value used in this case is 0.7, however, the value can be configured arbitrarily.

Whereas in the removal processing, an actual cubic volume of three-dimension CAD model and a cubic volume of a simplified model are derived from a detailed shape extracted from the three-dimension CAD model. Then a simplified model can be created by removing the detailed shape area based on the cubic volumes derived.

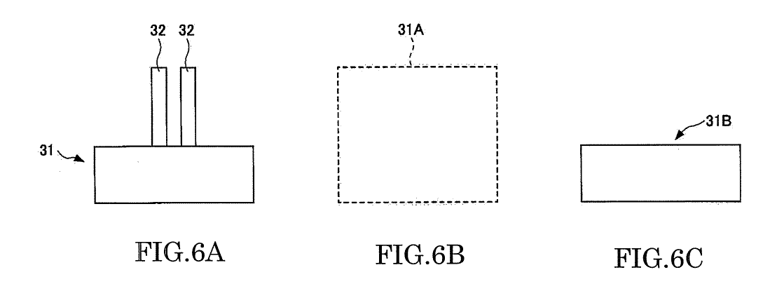

FIGS. 6A-6C illustrate the removal processing. FIG. 6A shows a front view of a three-dimension CAD model 31 and FIG. 6B shows a front view of a maximum outer shape 31A of the three-dimension CAD model 31 by dashed line. FIG. 6C shows a front view of a simplified model 31B having a simplified shape created by the removal processing. An actual cubic volume of the three-dimension CAD model 31 can be defined as V11 and a cubic volume of the simplified model (i.e. a cubic volume derived by reducing a cubic volume of the detailed shape from the cubic volume of the maximum outer shape 31A) can be defined as V12. Where a equation V11/V12<0.7 is satisfiable, a simplified model 31B is created by simplifying the detailed shape of the three-dimension CAD model 31, replacing the detailed shape with the simplified shape. In this case, a judgment value is 0.7, however, the value can be configured arbitrarily.

It can be efficient to register typical shapes such as a quadrangular prism, a circular cylinder and a certain shapes of cutouts on the database to compare them with detailed portion extracted from the three-dimension CAD model i.e., an object of the simplification. Where a prescribed condition of the simulation can be satisfied, the shape replacement processing can be performed by replacing the detailed shape with the simplified shape registered. The prescribed condition can be configured arbitrarily according to a maximum shape, a cross-section shape and a cubic volume of the three-dimension CAD model. The database can be stored in the memory section of the computer system 100 such as the memory unit 202, the disk drive 203, the HDD 204 or the external recording section of the computer system 100 such as the recording media 106. A shape replacement processing can be a processing to simplify detailed shape as well as said filling processing and removal processing, and so it can be also included into the shape simplification processing.

When performing the shape replacement processing of detailed shape, a simplified shape candidate approximating to the detailed shape can be extracted from the database under said prescribed condition. If there is a plurality of candidates matched, an operator can select one from among the candidates the computer to preferentially select the candidate in performing the shape replacement processing of a similar detailed shape. Which improves a processing speed and an accuracy of the shape replacement processing. Recognizing the detailed shape that has been replaced with the approximate candidate and registering the simplified shape created by said filling processing or the removal processing on the database facilitate the creation of the simplified model at high speed.

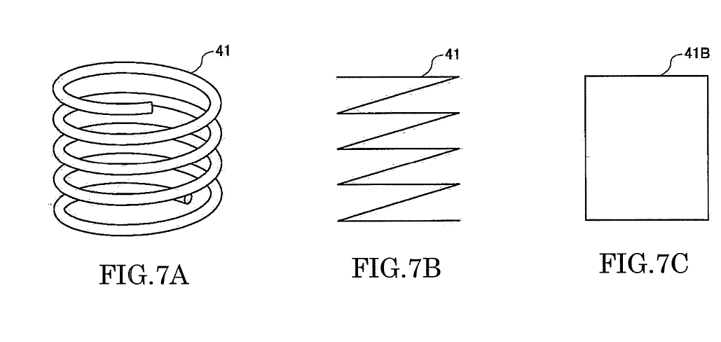

FIGS. 7A-7C show examples of three-dimension CAD models. FIG. 7A shows a prospective view of a three-dimension CAD model 41. FIG. 7B shows a front view of the three-dimension CAD model 41 and FIG. 7C shows a front view of a simplified model 41B having a simplified shape. FIGS. 7A and 7B show the three-dimension CAD model 41, a coil spring. If a candidate approximating to a detailed shape of the coil spring that satisfies a prescribed condition of the simulation is registered on the database, the shape replacement processing to replace the detailed shape of the three-dimension CAD model 41 is performed and thereby the simplified model 41B as per FIG. 7C can be created.

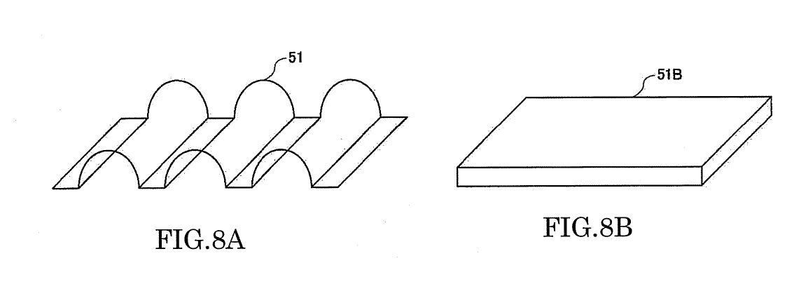

FIGS. 8A and 8B show example of three-dimension CAD models. FIG. 8A shows a prospective view of a three-dimension CAD model 51. FIG. 8B shows a prospective view of a simplified model 51B having a simplified shape. FIG. 8A shows a three-dimension CAD model, a corrugated plate. If a candidate approximating to a detailed shape of the corrugated plate that satisfies a prescribed conditions of the simulation can be registered on the database, the shape replacement processing to replace the detailed shape of the three-dimension CAD model 51 can be performed and thereby a simplified model 51B as per FIG. 8B is created.

Then the data of the simplified model thereby created can be simulated. The simulation includes the analyses, evaluation and optimization. Of which only the analyses can be performed, or the analyses and evaluation, or the analyses, evaluation and optimization can be performed.

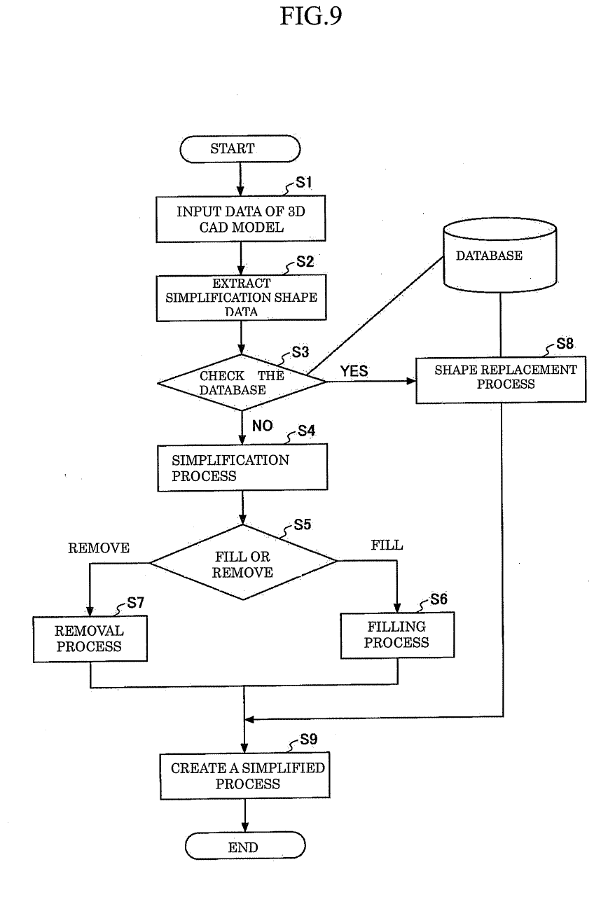

FIG. 9 shows a flow chart indicating processes of ans embodiment, which are performed by the program in the CPU 201. As per FIG. 9, data of three-dimension CAD model of a design object is input in an operation S1. The data of the three-dimension CAD model can be input from the input section or the memory section of the computer system 100, or from the other computer system, or the external recording media 106 of the computer system 100. In an operation S2, detailed shape information i.e., shape information of a simplification object is extracted from the data of the three-dimension CAD model in a manner above-mentioned. In an operation S3, whether a candidate approximating to the detailed shape extracted are registered on the database and the candidate is replaceable with the extracted shape are judged.

Where a judgment resulted in the operation S3 is NO, the simplification processing of the detailed shape extracted starts in the next operation, S4. In operation S5, the computer judges whether to fill or remove the detailed shape based on a comparison result of a cubic volume of a maximum outer shape of a design object product and an actual cubic volume of the object. Where a value of the comparison result is less than a prescribed value, the filling processing is chosen, so the procedure proceeds to an operation S6. Where the value is equal or greater than the prescribed value, the removal processing is chosen, so the procedure proceeds to an operation S7. In the operation S6, the filling processing described above is performed. Whereas in the operation S7, the removal processing described above is performed. After the operation S6 or S7, then the procedure proceeds to an operation S9. A simplified shape created by the operation S6 or S7 can be registered on the database in a manner described above.

In contrast, the judgment resulted in the operation S3 is YES, a candidate approximating to the detailed shape is extracted from the database and the shape replacement processing described above is performed in an operation S8. After the operation S8, the procedure proceeds to an operation S9.

In an operation S9, a simplified model of the three-dimension CAD model whose detailed shape is replaced with a simplified shape is created by the shape simplification processing (i.e., the filling processing, the removal processing or the shape replacing processing).

For convenience of explanation, the computer system shown in FIG. 1 is used in the next example embodiment.

Where the design is of a plurality of components and interference exists between the components, the simulations of the three-dimension CAD model could not be performed. The existence of the interference hinders certain types of simulations (especially the analyses). If so, a shape of the interfering components in the three-dimension CAD model should be modified to a shape having no interference.

In an embodiment, a modification time of the component's shape is curtailed and an efficiency of the modification is independent of the proficiency of an operator by modifying the shape of the component to a shape having no interference automatically. The modification of the interference can be performed by any of the following example methods, M1-M3.

Example modification method M1: derives a cubic volume of the interference between the components, and compares the interference with a cubic volume of the interfering components, then removes the interference from the component having a lower percentage of the interference in volume. Example modification method M2: makes the same comparison as in said modification method M1, and removes the interference from the component having a higher percentage of the interference in volume.

Example method M3: after removing the interference from all components having the interference, divides the interference into the number of the components interfering each other, then adds the divided interference to respective components.

An operator can select any of the example modification methods, M1-M3. A frequently-used modification method can be configured and preferably selected automatically in the CAD system.

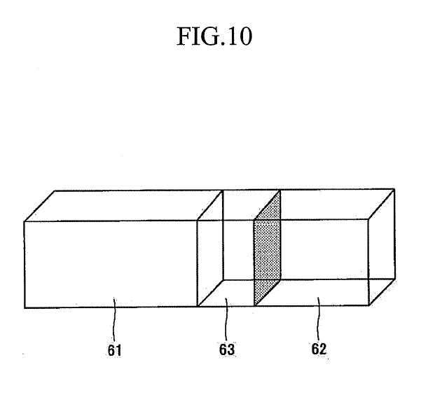

FIG. 10 shows a prospective view of a model illustrating the modification methods M1 and M2.

FIG. 10 shows a three-dimension CAD model comprised of components 61, 62 and an interference 63 existing between the component 61 and 62.

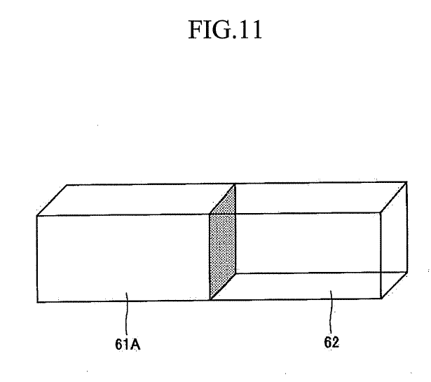

FIG. 11 shows a prospective view of a model illustrating the modification method M1. Defining a cubic volume of the component 61 as V21, a cubic volume of the component 62 as V22 and a cubic volume of the interference 63 as V23, the modification method M1 compares a ratio of the interference 63 to the component 61, V23/V21, with a ratio of the interference 63 to the component 62, V23/V22 in cubic volume. Hence (V23/V21)<(V23/V22), a component having a lower percentage of the interference 63 to its entire area is the component 61, so that the interference 63 is removed from the component 61 and the interference 63 shall be included in the component 62. Thus the component 61 is modified to a component 61A as illustrated in FIG. 11. As a result, the interference 63 is included in the component 62. Hence the interference 63 is removed from the component 61, and thereby the component 61A is created as shown in FIG. 11.

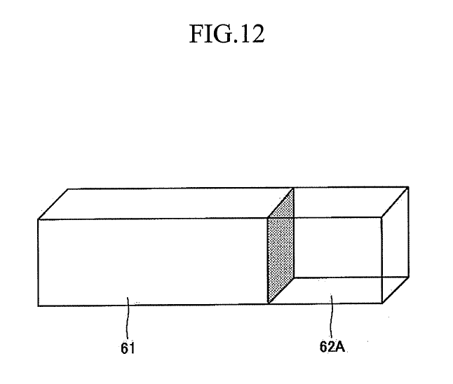

FIG. 12 shows a prospective view of a model illustrating the modification method M2. Defining the cubic volume of the component 61 as V21, the cubic volume of the component 62 as V22 and the cubic volume of the interference 63 as V23, the modification method M2 compares a ratio of the cubic volume of the interference 63 to the cubic volume of the component 61, V23/V21, with a ratio of the cubic volume of the interference 63 to the cubic volume of the component 62, V23/V22. Hence (V23/V21)<(V23/V22), a component having a higher percentage of the interference 63 to the its entire area is the component 62, so that the interference 63 is removed from the component 62 and the interference is included in the component 61. Thus the component 62 is modified to a component 62A from which the interference 63 is removed as shown in FIG. 12.

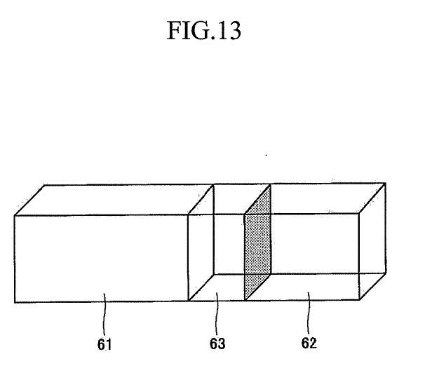

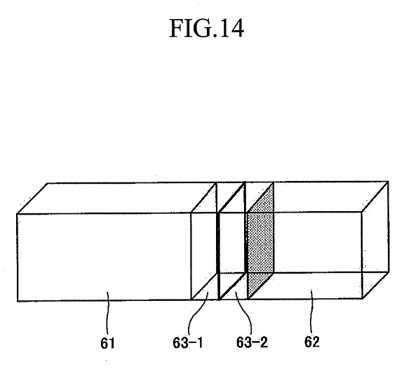

FIGS. 13-15 show perspective views of models illustrating the modification method M3. The three-dimension CAD model shown in FIG. 13 is comprised of the components 61, 62 and the interference 63 existing between the component 61 and 62.

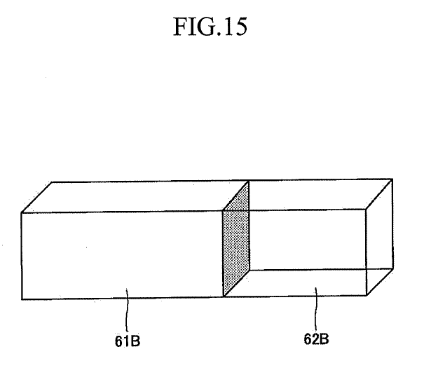

The modification method M3 removes the interference 63 from the object i.e., the components 61 and 62. Then the interference 63 is divided into the number of the components interfering each other, 61 and 62, (in this case, the number is two), divided portions 63-1 and 63-2. The divided portion 63-1 is added to the corresponding component 61 and the divided portion 63-2 is added to the corresponding component 62 as per FIG. 15, thereby the component 61 is modified to a component 61B from which the divided portion 63-2 is removed and the component 62 is modified to a component 62B from which the divided portion 63-1 is removed as per FIG. 15.

Depending on thee-dimension CAD model, the number of components having the interference could be two or more.

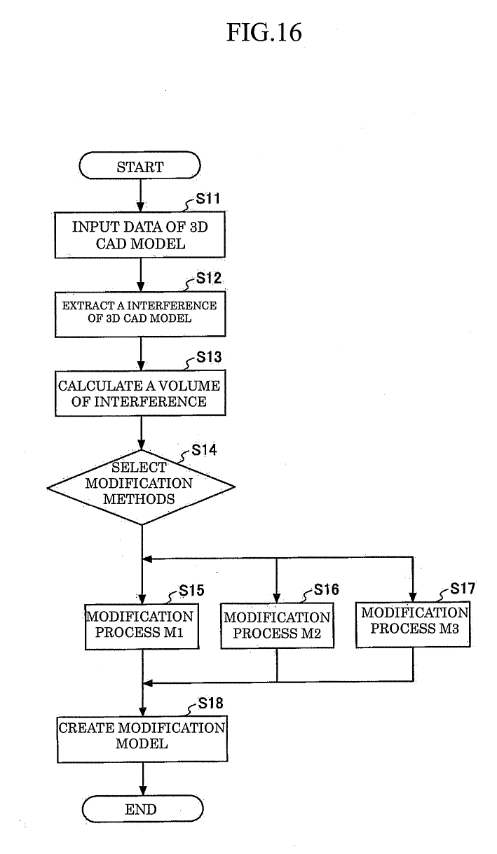

FIG. 16 shows a flow chart of example processes of this embodiment, performed by the program in the CPU 201. The three-dimension CAD model's data of the design object is input in an operation S11 as shown in FIG. 16. The data of the three-dimension CAD model can be input from the input section or the memory section of the computer system 100, or from the other computer system, or the external recording media 106 of the computer system 100. The interference between the components comprising the design object is extracted from the data of the three-dimension CAD model in an operation S12. The cubic volume of the interference is calculated in an operation S13. Then which of the modification methods, M1-M3, should be selected is judged in an operation S14. The modification method to be used can be selected every time by operator or config by default.

Where the modification method M1 is selected based on a judgment resulted in the operation S13, the process proceeds to an operation S15 and the modification M1 is performed. Where the modification method M2 is selected, the process proceeds to an operation S16 and the modification M2 is performed. Where the modification method M3 is selected, the process proceeds to an operation S17 and the modification method M3 is performed. After performing the operation S15, S16 or S17, the process proceeds to an operation S18 in which a modified model is created by modifying its interference.

As described above, the CPU 201 can extract the interference from the data of the three-dimension CAD model, modify the shape of the interfering component based on the interference extracted by any of said modification methods, M1-M3, create the modified model having no interference by modifying the interference's shape and simulate the simulation of the modified model's data.

Then the simulation of the modified model's data thereby created is performed. The simulation can include the analyses, evaluation and optimization, of which only the analyses can be performed, or the analyses and evaluation, or the analyses, evaluation and optimization can be performed.

The computer system shown in FIG. 1 can be used in another example embodiment. In the example embodiment, both of the disclosed shape simplification processing t and the disclosed modification processing of the interference are performed. The order to perform the shape simplification processing and the modification processing are not predetermined.

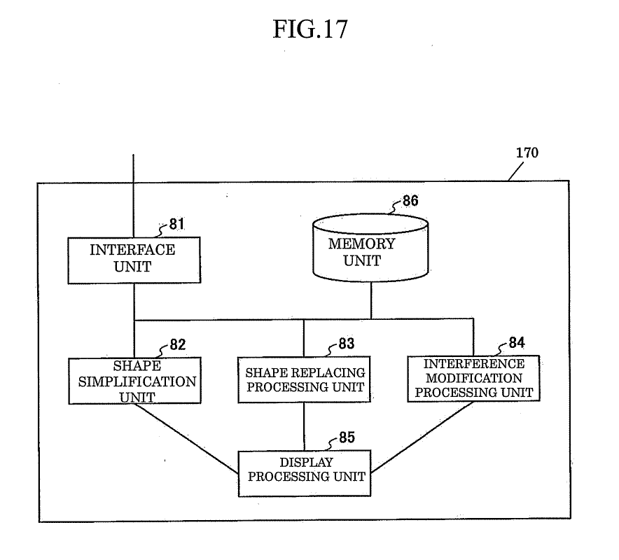

FIG. 17 shows a block diagram of another embodiment of a configuration of a CAD system 170. The CAD system 170 includes an interface unit 81, a shape simplification processing unit 82, a shape replacing processing unit 83, an interference modification processing unit 84, a display processing unit 85 and a memory unit 86. Respective component shown in FIG. 17 excluding the memory section can be achieved by the CPU 201 shown in FIG. 2, which includes memory unit 202, the disk drive 203, the memory section of the computer system 100 such as the HDD 204, and the external memory section of the computer system 100 such as the recording media 106.

The interface unit 81 can control input/output of the three-dimension CAD model's data into or from the CAD system. The shape simplification processing unit 82 performs the calculation for the shape simplification processing in the first embodiment. The shape replacing processing unit 83 performs the shape replacing processing in the first embodiment by referring the database stored in the memory section 86. The interference modification processing unit 84 performs the modification processing in the second embodiment by any of said modification method, M1-M3. The display processing unit 85 performs the display processing of the three-dimension CAD model, the simplified model or the modified model input into or output from the CAD system onto the display screen 102a of the display 102. The memory section 86 stores said database, various parameters for the computing and interim result obtaining from the computing. The memory section 86 also can store a program to make the CPU 201 perform the shape simplification processing unit 82, the shape replacing processing unit 83 and the interference modification processing unit 84.

The simulation of the data of the simplified model and/or the modified model thereby created are performed. The simulation includes the analyses, evaluation and optimization of which only the analyses can be performed, or the analyses and evaluation, or the analyses, evaluation and optimization can be performed.

The advantages of the embodiments include a design method, program, CAD system and computer-readable recording media that perform the simplification operation that creates the simplified model in which the unnecessary shape for the simulation is removed from the three-dimension CAD model and/or modification operation that modifies the three-dimension CAD model to the modified model having no interference automatically, and the efficiencies of the operations that can be independent of the operator's proficiency.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method for designing an apparatus or a part of an apparatus by a computer comprising:
extracting detailed shape information, which is unnecessary for a simulation, from data of a three-dimension CAD model;
simplifying the detailed shape information; and
creating a simplified model in which the detailed shape information included in the data of three-dimension CAD model is replaced with simplified shape information.

2. The method according to claim 1,
wherein the extracting the detailed shape information extracts a portion that a ratio of a distance between edges of the three-dimension CAD model, a length of an edge, or a distance between vertices to a maximum outer shape of the three-dimension CAD model is less than a prescribed ratio as the detailed shape.

3. The method according to claim 1,
wherein the simplifying selecting a filling processing that fills interspaces formed by the detailed shape or a removal processing that removes the detailed shape based on said detailed shape.

4. The method according to claim 3,
wherein the simplifying selecting the filling processing or the removal processing based on a cubic volume of the maximum outer shape of the three-dimension CAD model, an actual cubic volume of the three-dimension CAD model and a cubic volume of the simplified model.

5. The method according to claim 4,
wherein the simplifying executing the filling processing where the ratio of the cubic volume of the maximum outer shape of the three-dimension CAD model and the actual cubic volume of the three-dimension CAD model is equal or greater than a prescribed volume and the removal processing where a ratio of the cubic volume of the maximum outer shape of the three-dimension CAD model and the cubic volume of the simplified model is less than the prescribed value.

6. The method according to claim 1,
wherein the simplifying comparing the detailed shape with the simplified shape registered on a database where a prescribed condition of the simulation is satisfiable, and replacing the detailed shape information with an approximating simplified shape registered on the database.

7. The method according to claim 6,
wherein the prescribed condition is configured based on the maximum outer shape, a cross-section shape and the cubic volume of the three-dimension CAD model.

8. The method according to claim 1,
wherein the simulation includes an analysis, or the analysis and an evaluation, or the analysis, evaluation and an optimization.

9. A computer readable storage medium storing a program to cause a computer to operate as a design supporting apparatus and execute operations, the operations comprising:
extracting detailed shape information, which is unnecessary for a simulation, from data of a three-dimension CAD model;
simplifying the detailed shape information; and
creating a simplified model in which the detailed shape information included in the data of three-dimension CAD model is replaced with simplified shape information.

10. The computer-readable recording medium according to claim 9,
wherein the extracting the detailed shape information extracts a portion that a ratio of a distance between edges of the three-dimension CAD model, a length of an edge, or a distance between vertices to a maximum outer shape of the three-dimension CAD model is less than a prescribed ratio as the detailed shape.

11. The computer-readable recording medium according to claim 9,
wherein the simplifying selecting a filling processing that fills interspaces formed by the detailed shape or a removal processing that removes the detailed shape based on said detailed shape.

12. The computer-readable recording medium according to claim 11,
wherein the simplifying selecting the filling processing or the removal processing based on a cubic volume of the maximum outer shape of the three-dimension CAD model, an actual cubic volume of the three-dimension CAD model and a cubic volume of the simplified model.

13. The computer-readable recording medium according to claim 12,
wherein the simplifying executing the filling processing where the ratio of the cubic volume of the maximum outer shape of the three-dimension CAD model and the actual cubic volume of the three-dimension CAD model is equal or greater than a prescribed volume and the removal processing where a ratio of the cubic volume of the maximum outer shape of the three-dimension CAD model and the cubic volume of the simplified model is less than the prescribed value.

14. The computer-readable recording medium according to claim 9,
wherein the simplifying o comparing the detailed shape with the simplified shape registered on a database where a prescribed condition of the simulation is satisfiable, and replacing the detailed shape information with an approximating simplified shape registered on the database.

15. The computer-readable recording medium according to claim 14,
wherein the prescribed condition is configured based on the maximum outer shape, a cross-section shape and the cubic volume of the three-dimension CAD model.

16. The computer-readable recording medium according to claim 9,
wherein the simulation includes an analysis, or the analysis and an evaluation, or the analysis, evaluation and an optimization.

17. A design supporting system for designing an apparatus or a part of the apparatus comprising:
a extracting unit extracting the detailed shape information, which is unnecessary for the simulation, from the data of the three-dimension CAD model;
a simplifying unit simplifying the detailed shape information; and
a creating unit creating the simplified model in which the detailed shape information included in the three-dimension CAD model is replaced with the simplified shape information.

18. The design supporting system according to claim 17,
wherein the extracting unit extracting the detailed shape information extracts a portion that a ratio of a distance between edges of the three-dimension CAD model, a length of an edge, or a distance between vertices to a maximum outer shape of the three-dimension CAD model is less than a prescribed ratio as the detailed shape.

19. The design supporting system according to claim 17,
wherein the simplifying unit selecting a filling processing that fills interspaces formed by the detailed shape or a removal processing that removes the detailed shape based on said detailed shape, and selecting the filling processing or the removal processing based on a cubic volume of the maximum outer shape of the three-dimension CAD model, an actual cubic volume of the three-dimension CAD model and a cubic volume of the simplified model.

20. The design supporting system according to claim 17, wherein
wherein the simplifying unit comparing the detailed shape with the simplified shape registered on a database where a prescribed condition of the simulation is satisfiable, and replacing the detailed shape information with an approximating simplified shape registered on the database.
